(19) United States
(12) Patent Application Publication
(10) Pub. No.: US 2019/0308763 A1
(43) Pub. Date: Oct. 10, 2019

(54) PLASTIC PREFORM AND CONTAINER WITH MODIFIED NECK

(71) Applicant: Plastipak Packaging, Inc., Plymouth, MI (US)

(72) Inventors: Miguel Vieira, Vilvoorde (BE); Alain Dessaint, Kampenhout (BE); Laurent Degroote, Caestre (FR)

(21) Appl. No.: 16/376,269

(22) Filed: Apr. 5, 2019

Related U.S. Application Data
(60) Provisional application No. 62/652,977, filed on Apr. 5, 2018.

(51) Int. Cl. B65D 1/02; B65D 47/20; B65D 41/04

(52) U.S. Cl. CPC B65D 1/0246; B65D 2501/0063; B65D 41/0414; B65D 47/20

(57) ABSTRACT

A neck for a plastic preform and container that is suitable for holding pressurized contents includes a ring, an upper segment, a flange, and a lower segment. In embodiments the upper segment is disposed vertically between the ring and the flange and the lower segment is disposed vertically below the flange. In embodiments an inner radial wall segment of the ring of a neck is radially offset outwardly from an inner radial wall segment of the upper segment. In embodiments, the plastic container includes a closure, and may be configured to retain and dispense pressurized contents.

### CROSS-REFERENCE TO RELATED APPLICATION

This application claims the benefit of priority to U.S. Provisional Application Ser. No. 62/652,977, filed Apr. 5, 2018, which is fully incorporated herein by reference.

### TECHNICAL FIELD

The present invention relates to modified neck portions for plastic preforms and containers, and plastic containers with a modified neck that can retain and dispense pressurized contents (e.g., aerosol compositions).

### BACKGROUND

Containers for holding and dispensing pressurized contents are known in the art. Such containers have commonly been formed of metal to help withstand internal pressures associated with the contents. An example of such containers includes those intended to retain and dispense aerosol contents. It has been desirable to provide plastic containers that are suitable for retaining and dispensing pressurized contents, including aerosol compositions. There are advantages and challenges associated with providing plastic containers, including possibly all-plastic containers, that may be suitable for such applications. Advantages of plastic containers can include, inter alia, cost reductions and savings, increased design flexibility, ease of manufacture, and aesthetic features and options. Challenges can, however, include dealing with material characteristics (e.g., material effects under pressures and/or temperature changes) and material distributions and configurations, including those associated with neck portions of such containers.

Among other things, it can be desirable to provide a plastic container with an improved or modified neck that is suitable for holding and dispensing pressurized contents.

### SUMMARY

An improved neck for a plastic preform and container that is suitable for holding pressurized contents. The neck includes a ring, an upper segment, a flange, and a lower segment. In embodiments the upper segment is disposed vertically between the ring and the flange and the lower segment is disposed vertically below the flange. In embodiments an inner radial wall segment of the ring of a neck is radially offset outwardly from an inner radial wall segment of the upper segment. In embodiments, the plastic container includes a closure, and may be configured to retain and dispense pressurized contents.

### BRIEF DESCRIPTION OF THE DRAWINGS

Embodiments of the disclosure will now be described, by way of example, with reference to the accompanying drawings, wherein:

FIG. 1 is a perspective view of an embodiment of a neck of a plastic container or preform according to aspects or teachings of the present disclosure;

FIG. 2 is a side elevation view of an embodiment of a neck of a plastic container or preform as generally illustrated in FIG. 1;

FIG. 3 is partial section view along of the embodiment of a neck of a plastic container or preform shown in FIG. 2;

FIGS. 4A and 4B are rotated side elevation (engraving) views shown from an operator side and an opposing (non-operator) side, respectively;

FIG. 5 is top plan view of an embodiment of a neck as generally illustrated in FIGS. 4A and 4B;

FIG. 6 is a partial cross-sectional side elevation view (of the top view of FIG. 5) of an embodiment of a neck portion;

FIG. 7 is an enlarged view of portion VII shown in FIG. 6;

FIG. 8 is front elevation view of an embodiment of a neck of a plastic container or preform according to aspects or teachings of the present disclosure;

FIG. 9 is a cross-sectional view of a portion of an embodiment of a neck of a plastic container or preform according to aspects or teachings of the present disclosure;

FIG. 10 is a plan view of an embodiment of a neck of a plastic container or preform according to aspects or teachings of the present disclosure;

FIG. 11 is cross-sectional view of a portion of an embodiment of a plastic container or preform according to aspects or teachings of the present disclosure;

FIG. 12 is top plan view of an embodiment of a neck of a plastic container or preform according to aspects or teachings of the present disclosure; left and right side views of the neck are included as FIGS. 12A and 12B, respectively;

FIG. 13 is a side elevation view of an embodiment of a neck of a plastic container or preform as generally illustrated in FIG. 12;

FIG. 14 is a partial cross-sectional front view of a neck of a plastic container or preform as generally illustrated in FIG. 12;

FIG. 15 is an enlarged section view of a portion of a neck of a plastic container or preform as generally illustrated in FIG. 14;

FIG. 16 is a front elevation view of an embodiment of a neck of a plastic container or preform as generally illustrated in FIG. 12;

FIG. 17 is a perspective view of an embodiment of a neck of a plastic container or preform as generally illustrated in FIG. 12;

FIG. 18 is a perspective view of an embodiment of a neck of a plastic container or preform as generally illustrated in FIG. 12;

FIG. 19 is a cross-sectional view of an enlarged portion of a neck of a plastic container or preform as generally illustrated in FIG. 12;

FIG. 20 is a side elevation view of a neck of a plastic container or preform as generally illustrated in FIG. 12, including broken lines illustrating internal portions thereof;

FIG. 21 is a top plan view of a portion of the neck generally illustrated in FIG. 20;

FIG. 22 is a partial cross-sectional side view of a neck of a plastic container or preform as generally illustrated in FIG. 20;

FIG. 23 is a side elevation view of a neck of a plastic container or preform as generally illustrated in FIG. 20; and

FIG. 24 is a top plan view of a neck of a plastic container or preform as generally illustrated in FIG. 20.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined herein and by appended claims.

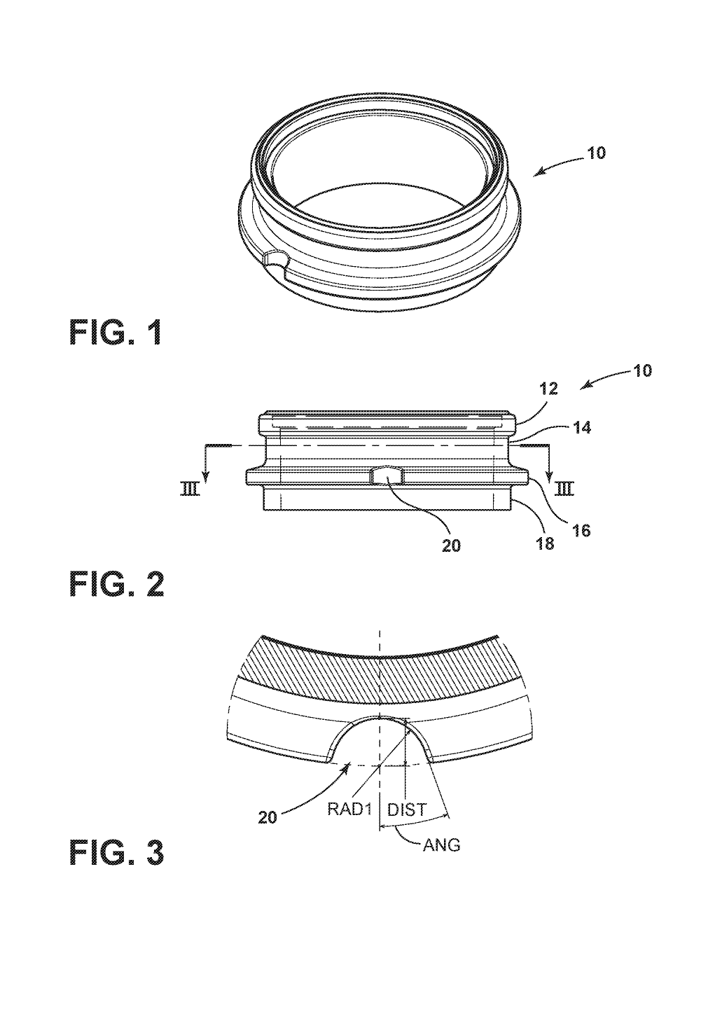

With reference to FIGS. 1 and 2, and without limitation, an embodiment of a container or preform neck 10 in accordance with aspects and teachings of the present disclosure is generally illustrated. The neck 10 may be the neck of a plastic preform (such as those disclosed further herein) that may be molded using various methods to form a resulting plastic container. Such preforms may be formed, for example and without limitation, by injection or compression molding and may be subjected to molding processes, such as two-stage blow molding (e.g., injection stretch blow molding (ISBM)), to form a plastic container.

As generally illustrated in FIG. 2, the neck 10 may include a rim portion or ring 12, an upper segment 14, a support portion or flange 16, and a lower segment 18. The flange 16 may extend radially outwardly from the neck and may be disposed between the upper segment 14 and the lower segment 18. A partial sectional view of the neck 10 is shown in FIG. 3. As generally illustrated, a portion of the flange 16 may include a formation or locator 20, which in embodiments may have a generally semi-circular shape or form. By way of example only, and without limitation, a neck 10 such as illustrated in FIGS. 1 and 2 may have a finish weight of about 2.34 grams. With other embodiments, for example and without limitation, a desirable or target weight of the neck may be 6.0 grams±0.3 grams. Further, with reference to FIG. 3, by way of example and without limitation, an embodiment of a partial portion of a neck in accordance with aspects or teachings of the present disclosure may have the following dimensions (which may be considered as having standard tolerances encountered within the field):
RAD1 (radius)—1.8 mm
DIST (distance)—1.8 mm
ANG (angle)—20 degrees

Embodiments of necks that are formed in accordance with aspects and teachings of the present disclosure may comprise thermoplastic material(s) such as, without limitation, polyethylene terephthalate (PET), polyethylene naphthalate (PEN), polycarbonate, polypropylene, PET-PEN copolymers, and other polymers or thermoplastic material that may be formed into the desired preforms and containers. In embodiments, containers (and their neck portions) may be formed by ISBM processing with extrusion grade PET (or EPET). Extrusion grade PET, or EPET, will generally have a comparatively (relative to non-extrusion grade PET) or sufficiently high intrinsic viscosity (IV, which may involve units of dl/g), and may be solid stated. In embodiments, a high IV will be above “bottle grade” IV of about 0.78-0.85 for carbonated soft drink grade applications) and may be about 0.96 to about 1.2, or higher, and may involve low crystallinity. Generally, EPET will need to have a high enough IV to hold up through the intended processing. With some embodiments, the IV may be about 1.1, and may be higher. With a lower IV, in some cases the container may not perform as well as desired in some testing, such as drop testing. However, if an IV is too high, challenges can be encountered, such as with associated hot bath testing. Consequently, it was found that for some embodiments there is a desirable range (or “sweet spot”) in which the material will perform well for both drop testing and hot bath testing.

Additionally, others in the field have commonly sought to add material thickness to neck portions to provide local reinforcement in the neck, including local reinforcement at or about a flange and/or lower segment of the neck. However, it has been found that with some neck configurations, such as disclosed herein, providing less material thickness associated with the flange and/or lower segment of the neck can provide equivalent or even better strength than reinforced containers with increased thickness that lack other aspects/teachings of the present disclosure.

In providing containers that embody aspects or teachings of the present disclosure that are suitable for retaining and dispensing pressurized contents, one or more (even all) of the following may be adjusted or controlled: (i) IV, (ii) wall thickness(es) and profiles, and/or (iii) associated processing. As noted, for applications a suitable IV may be employed. For embodiments, wall thickness(es) and distributions may be tightly controlled. For example and without limitation, various portions or segments of a container may be varied to help handle or address anticipated internal pressure (e.g., such as pressurization associated with aerosol contents). Additionally, with embodiments, associated processing may involve additional cooling, which may provide extra or added crystallization (e.g., boosted through cooling). With embodiments, the amount of crystallization may be increased beyond (e.g., at least 1-2% beyond) what is typically associated with the conventional crystallization of a plastic (e.g., PET) container.

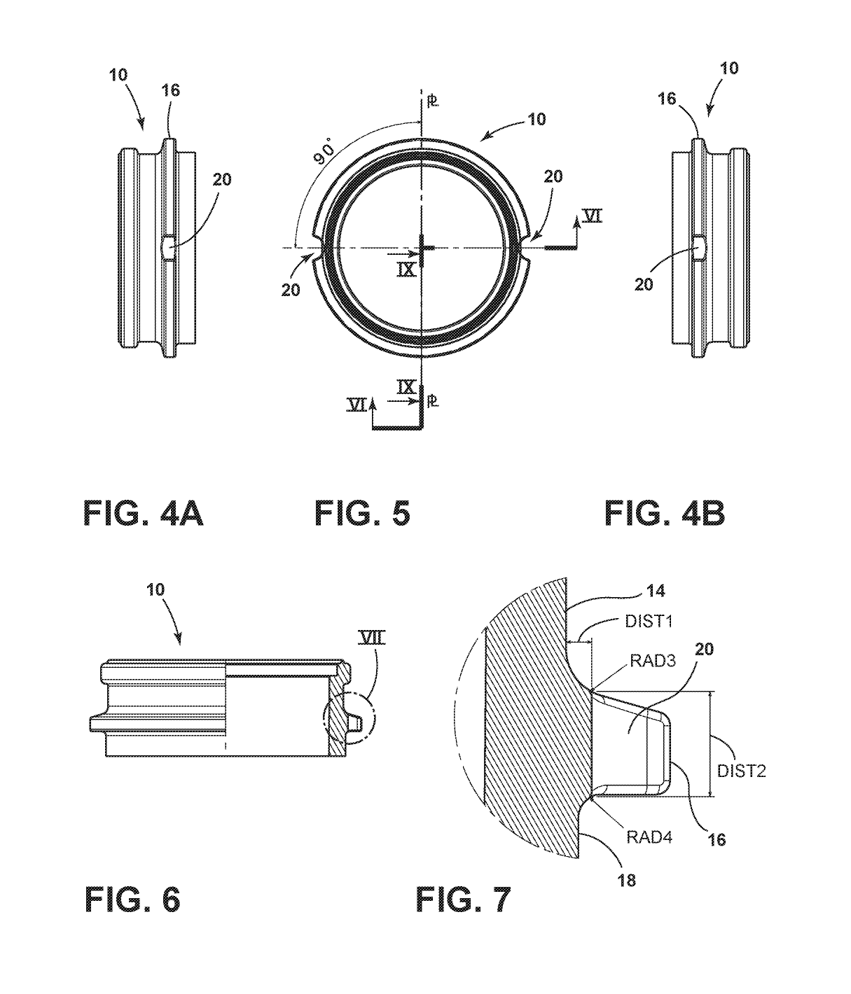

FIGS. 4A, 4B, and 5 generally illustrate a neck 10 shown from different views. FIG. 6 generally illustrates a partial sectional view of the neck 10 such as shown in FIG. 5. An enlarged portion thereof is generally illustrated in FIG. 7. Transitions from an upper segment 14 to an upper portion of flange 16 (with locator 20 included) and from a lower portion of the flange 16 to a lower segment 18 are generally illustrated in FIG. 7. With reference to FIG. 7, by way of example and without limitation, an embodiment of a portion of a neck in accordance with aspects or teachings of the present disclosure may have the following dimensions (which may be considered as having standard tolerances encountered within the field):
DIST1 (distance)—0.55 mm
DIST2 (distance)—2.26 mm
RAD2 (radius)—0.2 mm
RAD4 (radius)—0.2 mm

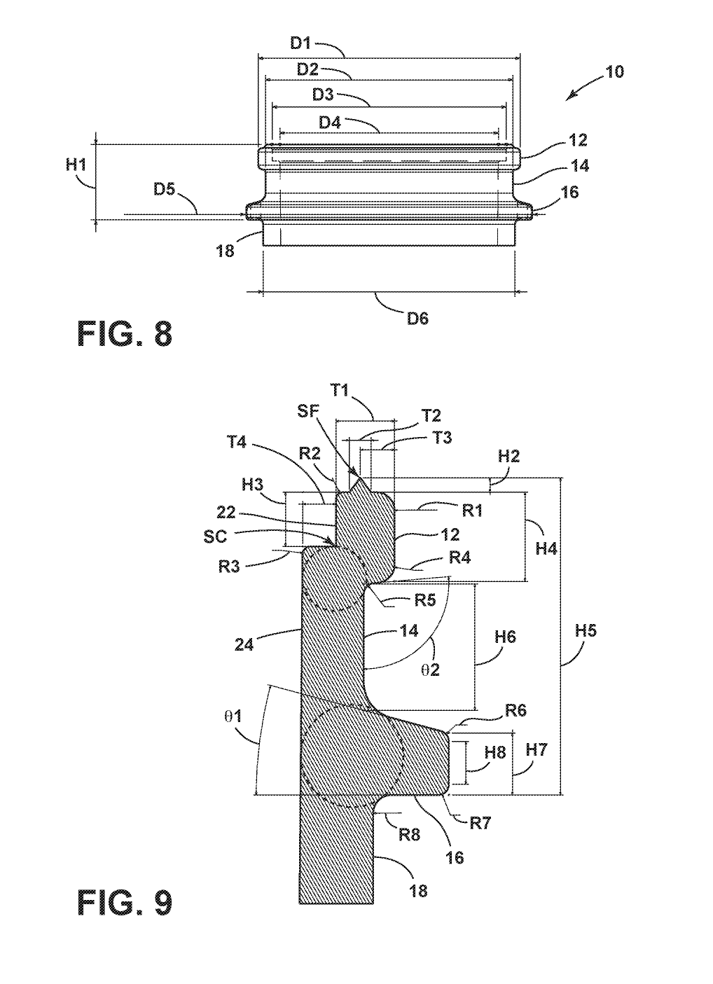

With reference to FIG. 8, several dimensions associated with an embodiment of a neck 10 having aspects/features of the present disclosure are generally illustrated. By way of example, and without limitation, an embodiment of a neck in accordance with aspects or teachings of the present disclosure may have the following dimensions (which may be considered as having standard tolerances encountered within the field):
D1 (diameter)—30.5 mm
D2 (dia.)—28.8 mm
D3 (dia.)—27.26 mm
D4 (dia.)—25.46 mm
D5 (dia.)—33.5 mm
D6 (dia.)—29.32 mm
H1 (distance)—8.76 mm

With reference to FIG. 9, dimensions associated with wall profiles and wall thicknesses associated with an embodiment of a neck 10 are generally illustrated. The illustrated embodiment additionally depicts a formation (e.g., sharp formation SF) extending vertically upward from an upper portion of the ring 12, and a sharp corner SC associated with an interior surface of the ring 12. In embodiments, the sharp corner SC may provide a transition that is at or about 90°. By way of example, and without limitation, an embodiment of a neck in accordance with aspects or teachings of the present disclosure may have the following dimensions (which may be considered as having standard tolerances within the field):
T1 (thickness)—1.62 mm
T2 (thickness)—0.6 mm
T3 (thickness)—0.95 mm
T4 (distance)—0.92 mm
H2 (distance)—0.4 mm
H3 (distance)—1.5 mm
H4 (distance)—2.46 mm
H5 (distance)—8.76 mm
H6 (distance)—3.49 mm
H7 (distance)—1.71 mm
H8 (distance)—1.18 mm
Ø1—15°
Ø2—95°
R1 (radius)—0.5 mm
R2 (radius)—0.2 mm
R3 (radius)—0.2 mm
R4 (radius)—0.5 mm
R5 (radius)—0.3 mm
R6 (radius)—0.3 mm
R7 (radius)—0.3 mm
R8 (radius)—0.5 mm

Further, as generally illustrated in FIG. 9, a ring 12 may be radially offset (e.g., outwardly) from a portion of the upper segment 14. In embodiments, an inner radial wall segment 22 of a ring 12 may be radially offset outwardly from an inner radial wall segment 24 of an upper segment 14. In an embodiment, for example and without limitation, the radial offset may be at least 0.90 mm, may be at least about 0.92 mm, or may be equal to or about 0.92 mm.

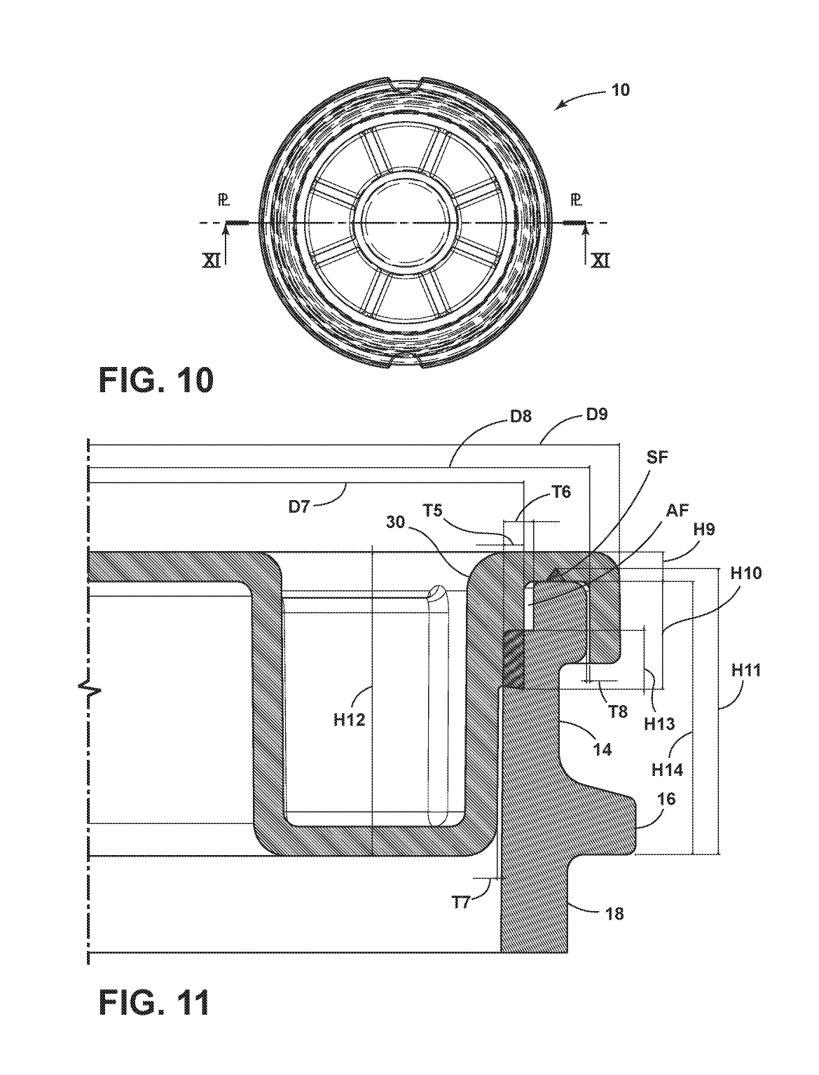

FIGS. 10 and 11 illustrate top view and a sectional view of a portion of a neck 10 for a plastic container. With reference to FIG. 11, a cover or closure 30 is included and dimensions associated with wall profiles and wall thicknesses associated with an embodiment of a neck 10 are generally illustrated. A closure 30 may be configured to cover an opening associated with the neck 10 of a plastic container. The cover 30 may include additional elements or component, such as a valve for dispensing container contents. As generally shown, a portion of the closure 30 may extend over and around a portion of the ring 12 of the neck 10. It is noted that embodiments of necks in accordance with the teachings of the present invention may be compatible with metal and plastic valves. Additionally, in embodiments, a valve may comprise a valve that is spin-welded.

The illustrated embodiment in FIG. 11 additionally includes a formation (e.g., sharp formation SF) extending vertically upward from an upper portion of the ring 12, and an area for filling or decompression AF (shown radially interior to ring 12 between the ring 12 and a portion of the closure 30). By way of example, and without limitation, an embodiment of a neck in accordance with aspects or teachings of the present disclosure may have the following dimensions (which may be considered as having standard tolerances within the field):
T5 (thickness)—0.61 mm
T6 (thickness)—0.92 mm
T7 (thickness)—0.15 mm
T8 (thickness)—0.0.1 mm
H9 (distance)—0.9 mm
H10 (distance)—3.3 mm
H11 (distance)—8.76 mm
H12 (distance)—9.3 mm
H13 (distance)—1.8 mm
H14 (distance)—8.36 mm
D7 (dia.)—26.65 mm
D8 (dia.)—30.7 mm
D9 (dia.)—32.51 mm

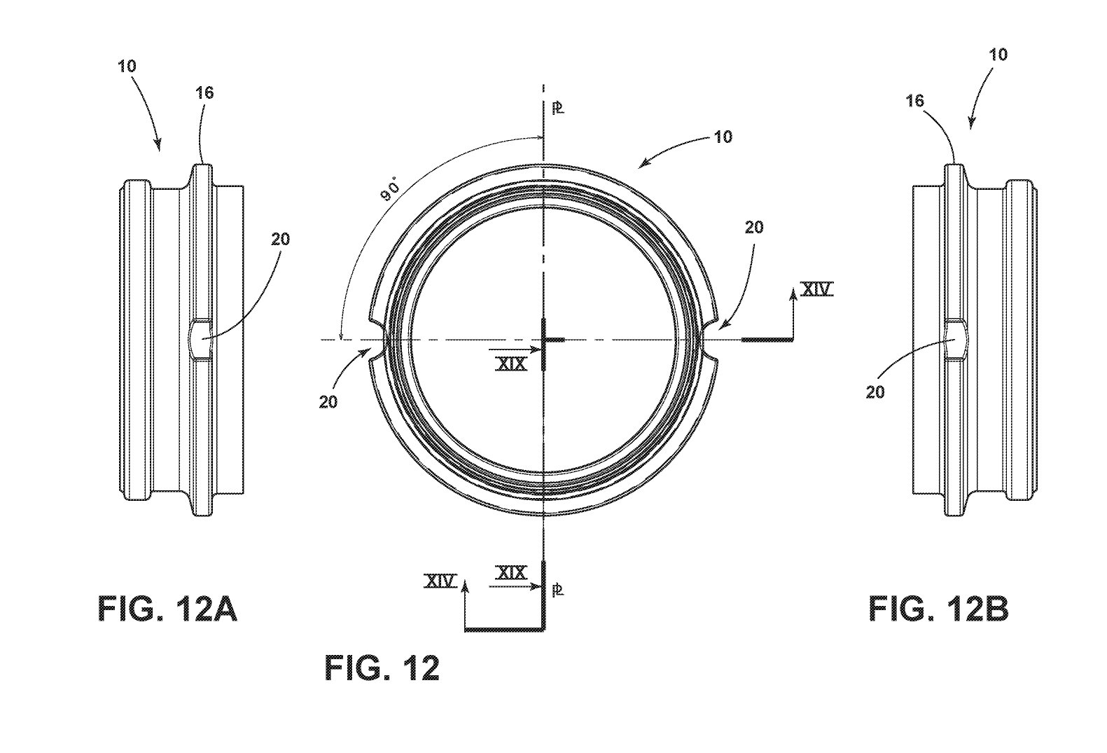

FIGS. 12 through 24 generally illustrate additional views and/or features associated with other embodiments of a neck for a preform or container.

FIG. 12 is top plan view of an embodiment of a neck of a plastic container or preform according to aspects or teachings of the present disclosure. A left side view of the neck shown in FIG. 12 is illustrated in FIG. 12A, and a right side view of the neck is illustrated in FIG. 12B.

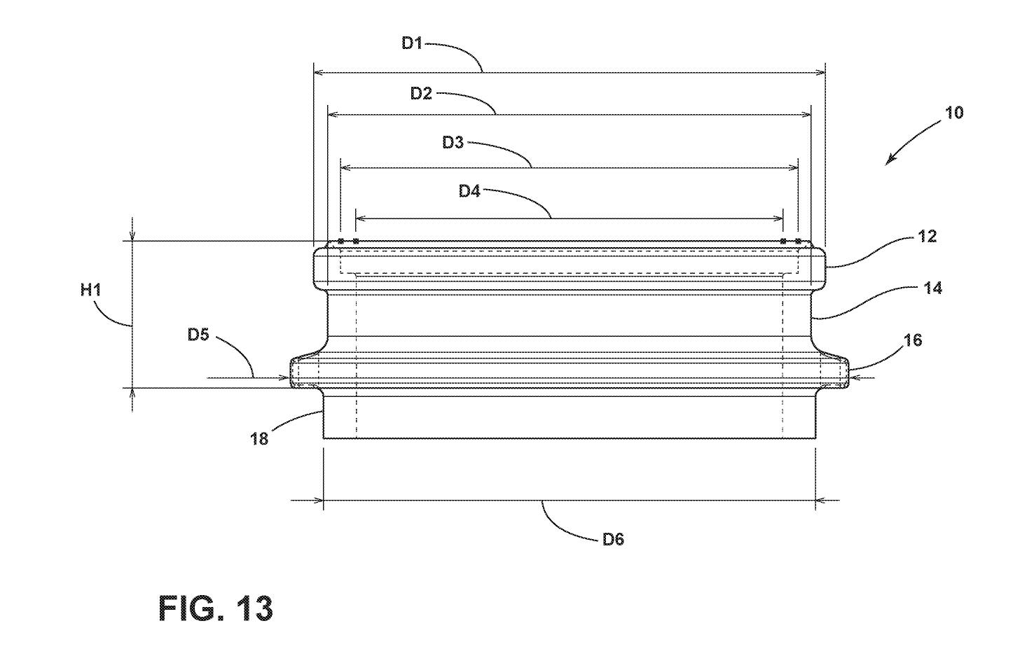

FIG. 13 generally illustrates a side elevation view of an embodiment of a neck of a plastic container or preform, such as generally illustrated in FIG. 12. With reference to FIG. 13, several dimensions associated with an embodiment of a neck 10 having aspects/features of the present disclosure are generally illustrated. By way of example, and without limitation, an embodiment of a neck in accordance with aspects or teachings of the present disclosure may have the following dimensions (which may be considered as having standard tolerances encountered within the field):
D1 (diameter)—31.6 mm
D2 (dia.)—28.8 mm
D3 (dia.)—27.26 mm
D4 (dia.)—25.42 mm
D5 (dia.)—33.25 mm
D6 (dia.)—29.32 mm
H1 (distance)—8.76 mm

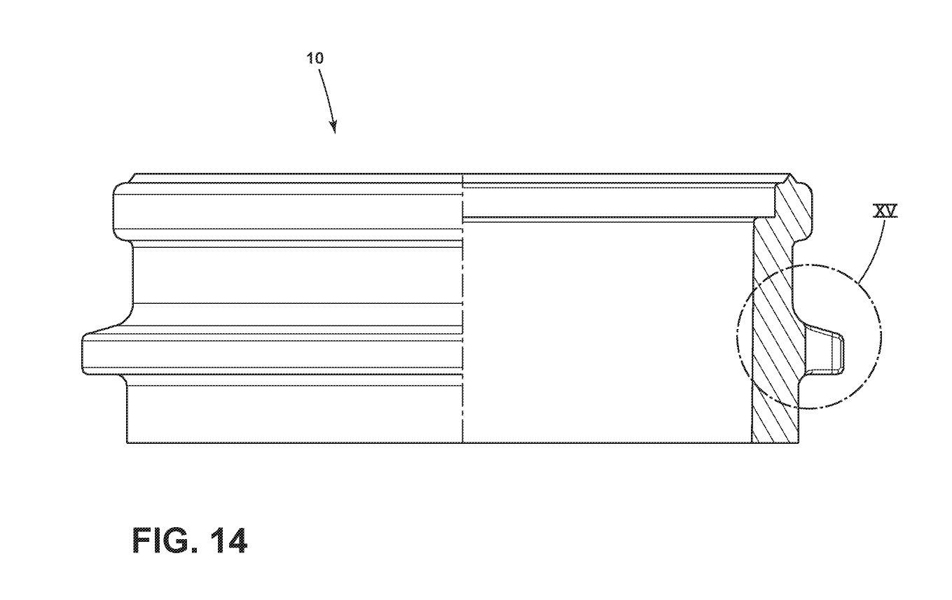

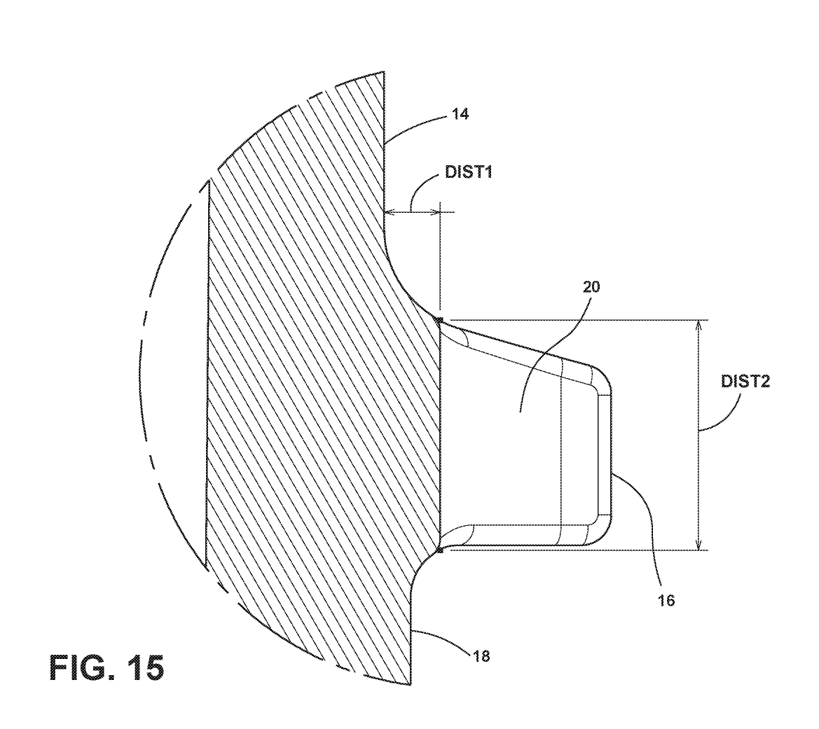

While, FIG. 14 generally illustrates a partial cross-sectional front view of a neck of a plastic container or preform as generally illustrated in FIG. 13. FIG. 15 depicts an enlarged section view of a portion of a neck of a plastic container or preform such as generally illustrated in FIG. 14. With reference to FIG. 15, by way of example, and without limitation, an embodiment of a portion of a neck in accordance with aspects or teachings of the present disclosure may have the following dimensions (which may be considered as having standard tolerances encountered within the field):
DIST1 (distance)—0.55 mm
DIST2 (distance)—2.26 mm

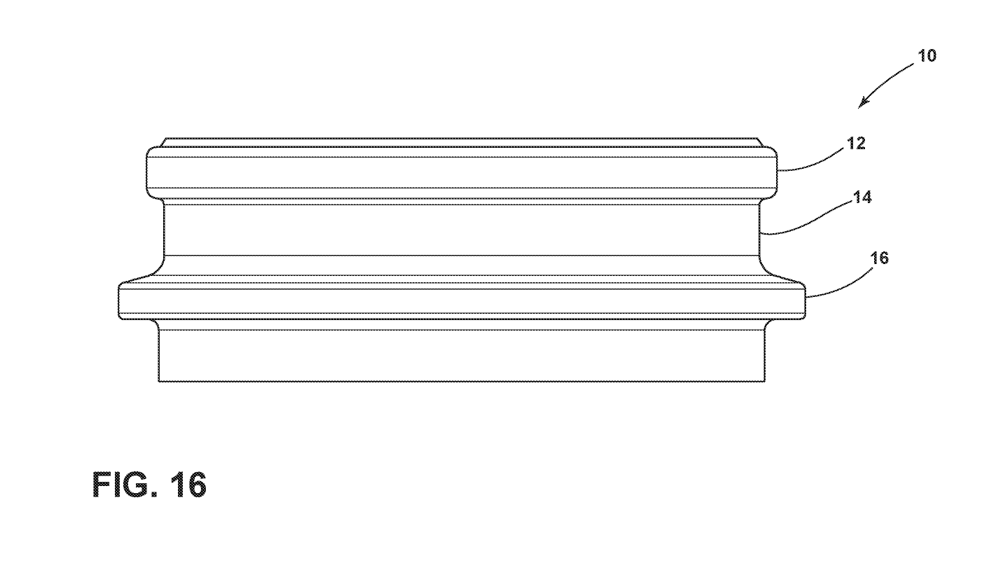

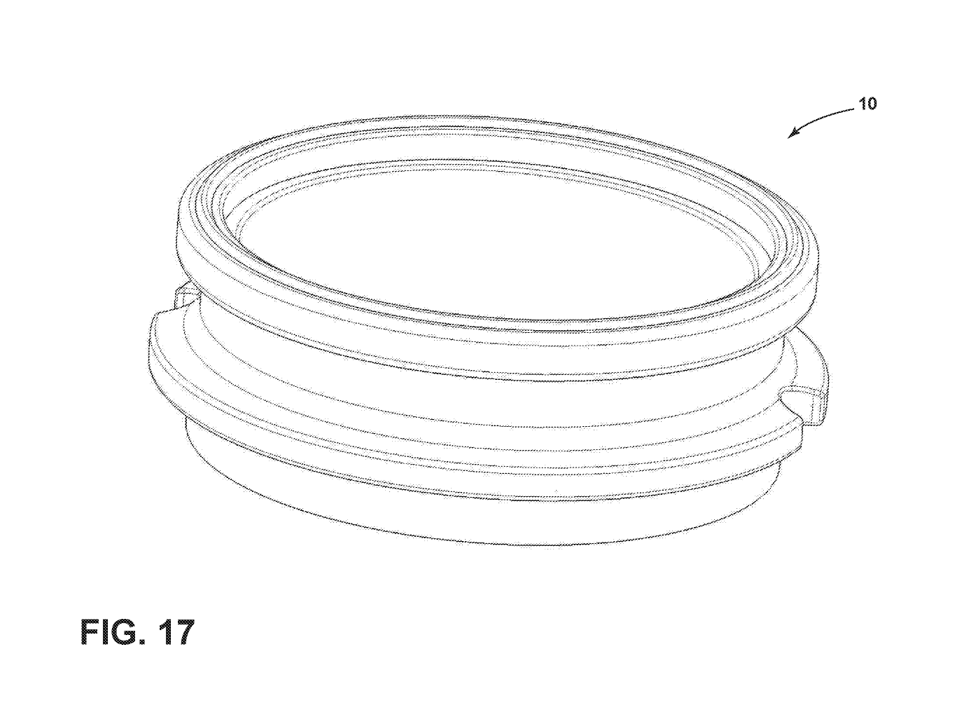

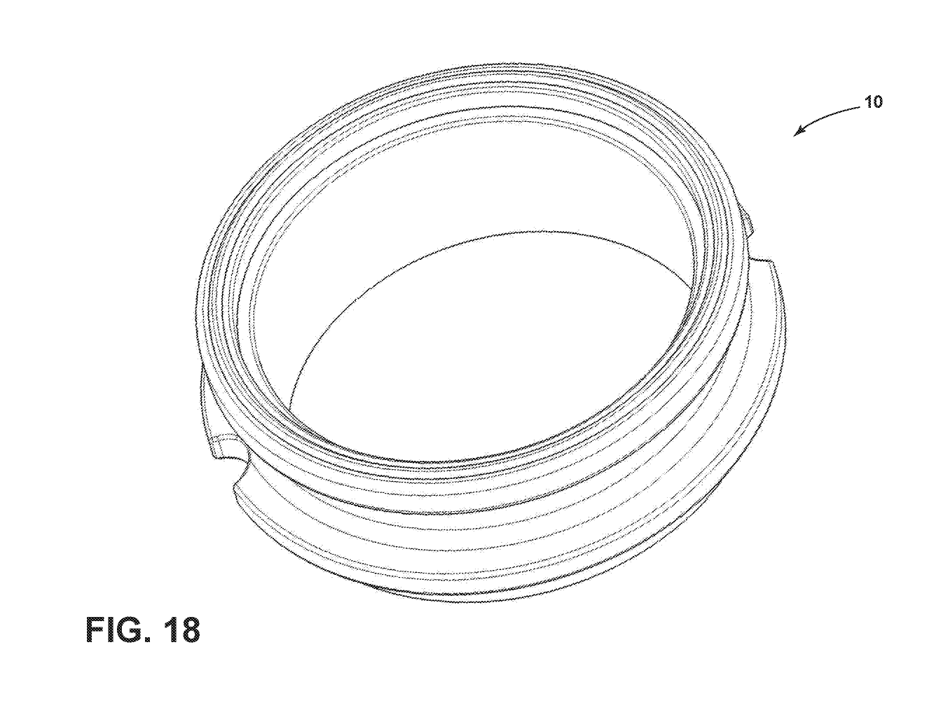

FIG. 16 is a front elevation view of an embodiment of a neck of a plastic container or preform, such as generally illustrated in FIG. 12. FIG. 17 is a perspective view of an embodiment of a neck of a plastic container or preform as generally illustrated in FIG. 12. FIG. 18 is another perspective view of an embodiment of a neck of a plastic container or preform, such as generally illustrated in FIG. 12.

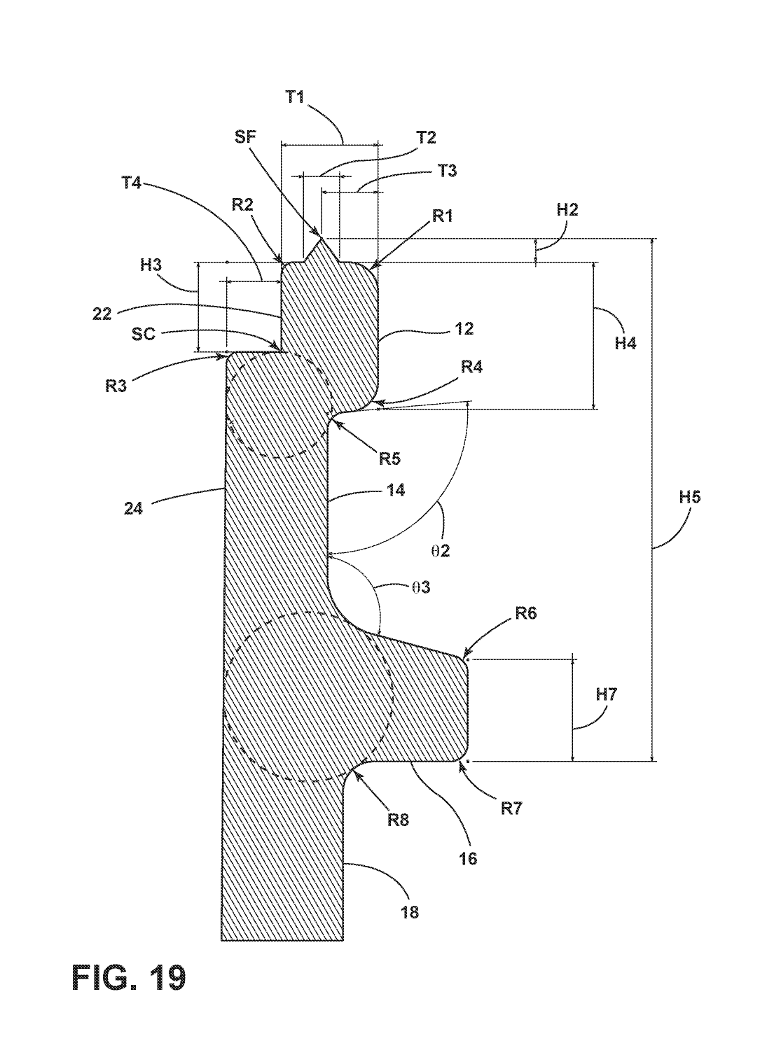

FIG. 19 is a cross-sectional view of an enlarged portion of an embodiment of a neck of a plastic container or preform, such as generally illustrated in FIG. 12. With reference to FIG. 19, dimensions associated with wall profiles and wall thicknesses associated with an embodiment of a neck 10 are generally illustrated. The illustrated embodiment additionally depicts a formation (e.g., sharp formation SF) extending vertically upward from an upper portion of the ring 12, and a sharp corner SC associated with an interior surface of the ring 12. By way of example, and without limitation, an embodiment of a neck in accordance with aspects or teachings of the present disclosure may have the following dimensions (which may be considered as having standard tolerances within the field):
T1 (thickness)—2.17 mm
T2 (thickness)—0.8 mm
T3 (thickness)—1.2 mm
T4 (thickness)—0.91 mm
H2 (distance)—0.4 mm
H3 (distance)—1.5 mm
H4 (distance)—2.46 mm
H5 (distance)—8.76 mm
H7 (distance)—1.71 mm
H8 (distance)—1.18 mm
Ø2—95°
Ø3—105°
R1 (radius)—0.5 mm
R2 (radius)—0.2 mm
R3 (radius)—0.2 mm
R4 (radius)—0.5 mm
R5 (radius)—0.3 mm
R6 (radius)—0.3 mm
R7 (radius)—0.3 mm
R8 (radius)—0.5 mm

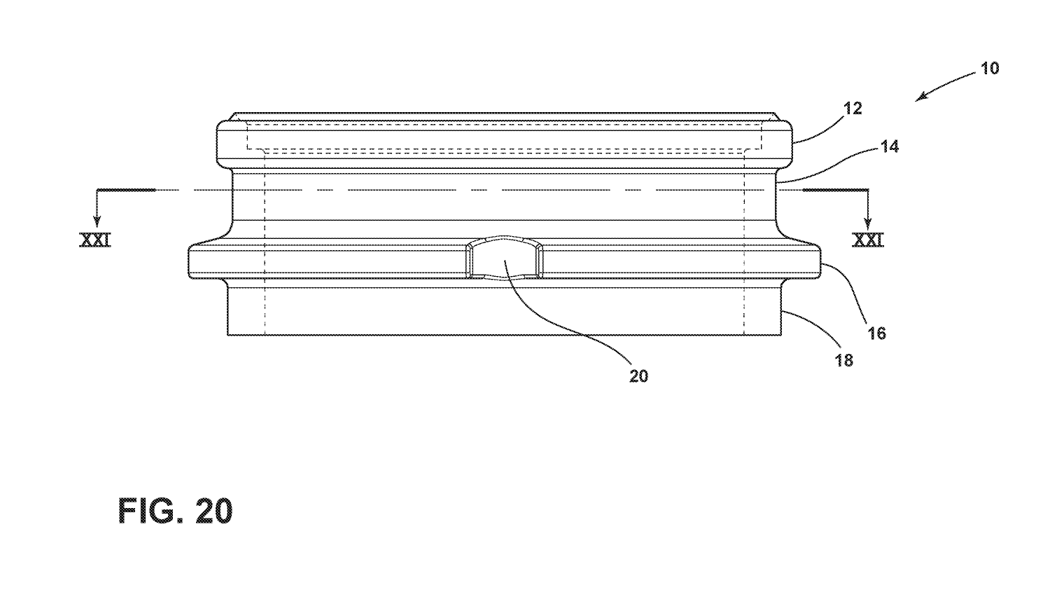

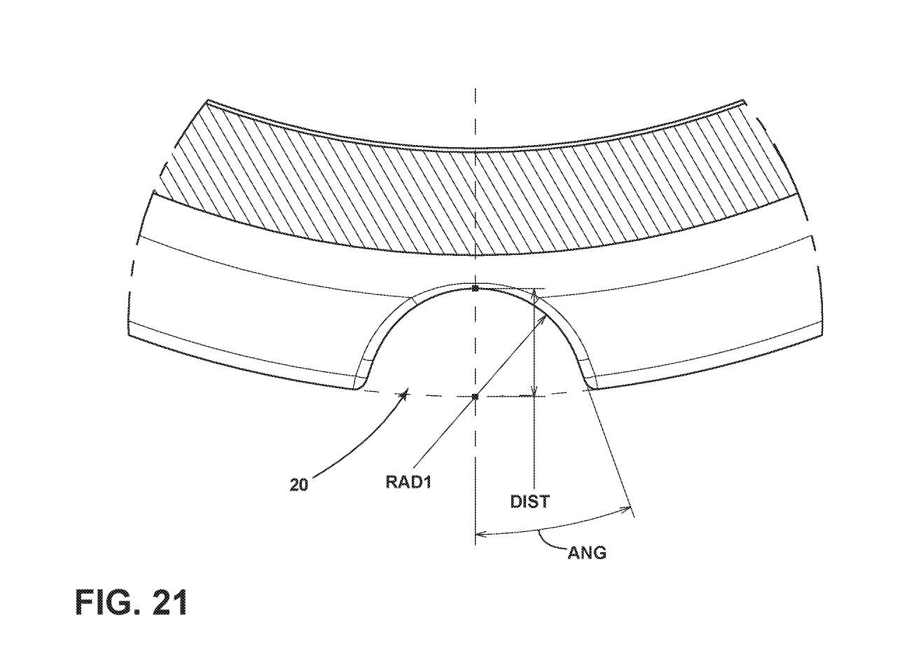

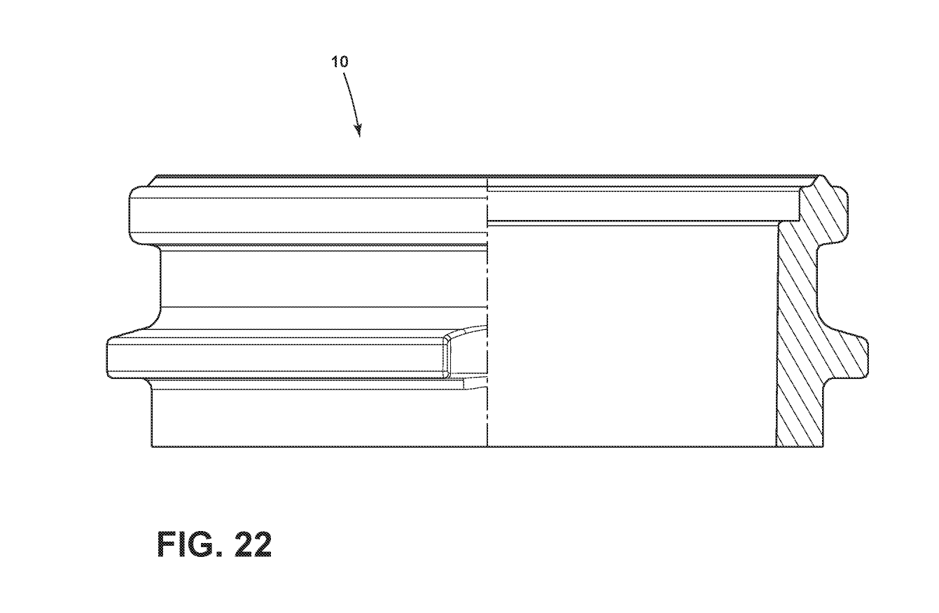

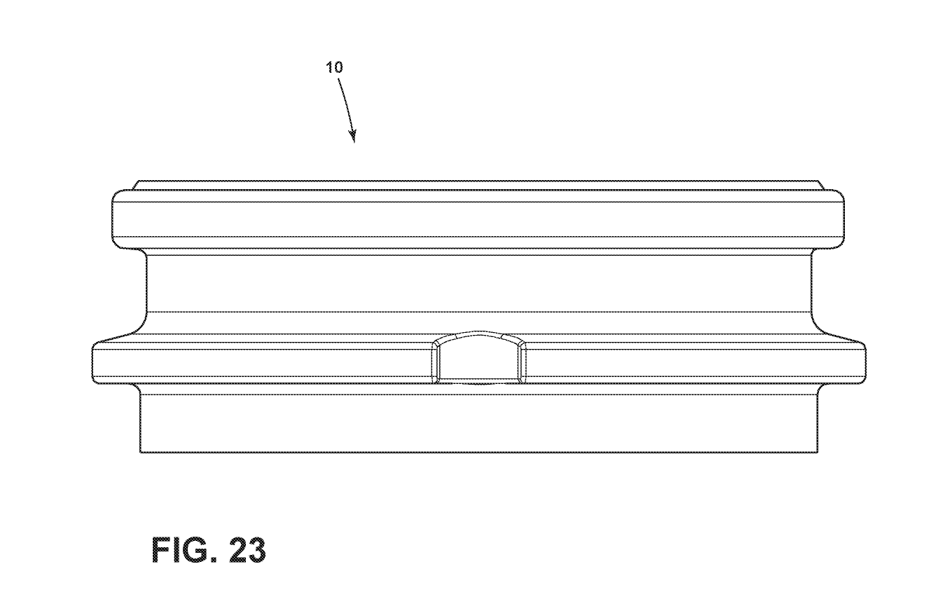

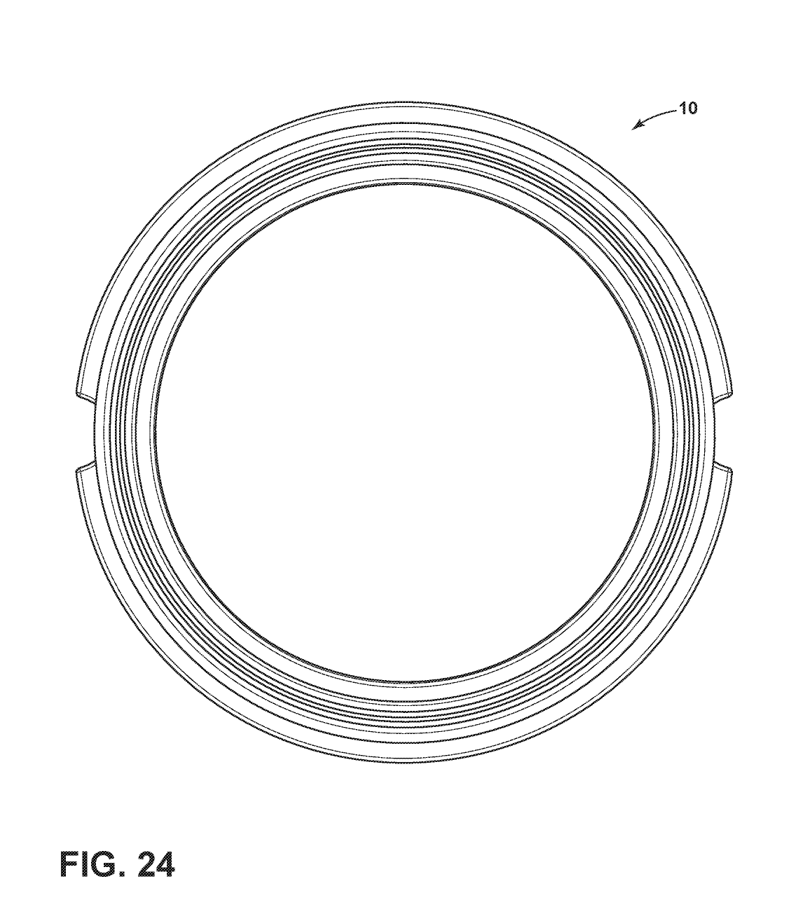

FIG. 20 is a side elevation view of a neck of an embodiment of a plastic container or preform, such as generally illustrated in FIG. 12, and including broken lines illustrating internal portions thereof. FIG. 21 is a top plan view of a portion of the neck generally illustrated in FIG. 20. FIG. 22 is a partial cross-sectional side view of a neck of a plastic container or preform, such as generally illustrated in FIG. 20. FIG. 23 is a side elevation view of a neck of an embodiment of a plastic container or preform, such as generally illustrated in FIG. 20, and FIG. 24 is a top plan view of an embodiment of a neck of a plastic container or preform, such as generally illustrated in FIG. 20.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A neck for a plastic container suitable for holding pressurized content, the neck comprising:
a ring;
a flange;
an upper segment disposed between the ring and the flange; and
a lower segment disposed below the flange;
wherein an inner radial wall segment of the ring is radially offset outwardly from an inner radial wall segment of the upper segment.

2. The neck of claim 1, wherein the neck is comprised of plastic.

3. The neck of claim 1, wherein the neck is comprised entirely of plastic.

4. The neck of claim 1, wherein the radial offset is at least 0.90 mm.

5. The neck of claim 1, wherein the radial offset is about 0.92 mm.

6. The neck of claim 1, including a locator.

7. The neck of claim 6, wherein the locator is provided on the flange.

8. The neck of claim 6, wherein the locator has a generally semi-circular shape.

9. The neck of claim 1, wherein the neck includes a plurality of locators.

10. The neck of claim 1, wherein a neck finish of the neck has a weight of about 2.34 grams.

11. The neck of claim 1, wherein the neck has a weight of 6.0 grams ±0.3 grams.

12. The neck of claim 1, wherein the neck is comprised of extrusion grade PET (EPET).

13. The neck of claim 1, wherein the neck is comprised of plastic having an intrinsic viscosity of about 1.1.

14. The neck of claim 1, wherein the ring includes a formation extending vertically upward from an upper portion of the ring.

15. An assembly for a plastic container, the assembly comprising a neck as recited in claim 1 and a closure configured to cover an opening of the neck of said plastic container.

16. The assembly of claim 15, wherein the closure includes a valve.

17. The assembly of claim 15, wherein a portion of the closure extends over and around a portion of the ring of the neck.

18. The assembly of claim 17 wherein the portion of the closure that extends over and around a portion of the ring substantially covers an outer radial portion of the ring.

19. The assembly of claim 17, wherein the upwardly vertical formation of the ring is disposed within a portion of the closure that extends over and around the ring of the neck.

20. The assembly of claim 15, wherein the radial offset of the inner radial wall segment of the ring from the inner radial wall segment of the upper segment of the neck is covered by the closure and provides an area for filling or decompression.
